(19) United States
(12) Patent Application Publication
(10) Pub. No.: US 2018/0061176 A1
(43) Pub. Date: Mar. 1, 2018

(54) INCREMENTING FEATURE IN GAMING DEVICE

(71) Applicant: KING SHOW GAMES, INC., Minnetonka, MN (US)

(72) Inventors: Bradley BERMAN, Minnetonka, MN (US); Jacob LAMB, Maple Grove, MN (US); Anthony GROTTE, Buffalo, MN (US)

(21) Appl. No.: 15/804,674

(22) Filed: Nov. 6, 2017

Related U.S. Application Data
(63) Continuation-in-part of application No. 14/927,447, filed on Oct. 29, 2015.
(60) Provisional application No. 62/419,389, filed on Nov. 8, 2016.
(60) Provisional application No. 62/072,168, filed on Oct. 29, 2014.

(51) Int. Cl. G07F 17/32

(52) U.S. Cl. CPC G07F 17/3213; G07F 17/3244; G07F 17/3269; G07F 17/3288

(57) ABSTRACT

Embodiments of the present invention set forth systems, apparatuses and methods for implementing an incrementing feature in gaming devices. Accordingly, a gaming device can be configured to generate a game outcome in response a wager and determine if an incrementing symbol is present on a game grid when the generated game outcome is shown on a display of the gaming device. When the incrementing symbol is present, a processor is further operable to increment the incrementing symbol while maintaining at least the initial position of the incrementing symbol in the game grid during a subsequent game event.

### RELATED APPLICATIONS

This application claims the benefit of Provisional Patent Application No. 62/419,389 filed on Nov. 8, 2016, to which priority is claimed pursuant to 35 U.S.C. §119(e), and is a continuation-in-part of U.S. patent application Ser. No. 14/927,447 filed on Oct. 29, 2015, which claims the benefit of Provisional Patent Application No. 62/072,168 filed on Oct. 29, 2014, to which priority is claimed pursuant to 35 U.S.C. §119(e), all of which are incorporated herein by reference in its entirety.

### FIELD OF THE INVENTION

This disclosure relates generally to games, and more particularly to systems, apparatuses and methods for implementing an incrementing feature in gaming devices.

### BACKGROUND

Casino games such as poker, slots, and craps have long been enjoyed as a means of entertainment. Almost any game of chance that can be played using traditional apparatus (e.g., cards, dice) can be simulated on a computer. The popularity of casino gambling with wagering continues to increase, as does recreational gambling such as non-wagering computer game gambling. It is also likely that most new games will be implemented, at least in part, using computerized apparatus.

One reason that casino games are widely implemented on computerized apparatus is that computerized games are highly adaptable, easily configurable and re-configurable, and require minimal supervision to operate. For example, the graphics and sounds included in such games can be easily modified to reflect popular subjects, such as movies and television shows.

Computer gaming devices can also be easily adapted to provide entirely new games of chance that might be difficult to implement using mechanical or discrete electronic circuits. Because of the ubiquity of computerized gaming machines, players have come to expect the availability of an ever wider selection of new games when visiting casinos and other gaming venues. Playing new games adds to the excitement of “gaming” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill. In some jurisdictions, the absence of skill when determining awards during game play is a requirement.

The present disclosure describes methods, systems, and apparatus that provide for new and interesting gaming experiences, and that provide other advantages over the prior art.

### SUMMARY

To overcome limitations in the prior art described above, and to overcome other limitations that will become apparent upon reading and understanding the present specification, embodiments of the present invention are directed to an apparatus, system, computer readable storage media, and/or method that involve or otherwise facilitate implementing an incrementing feature in gaming devices. In one embodiment, a gaming device includes a display showing a game grid and a processor, where the processor is operable to receive a wager on a gaming event, determine an outcome for the gaming event, and determine if an incrementing symbol is present on a game grid when the determined game outcome is shown on the display. When the incrementing symbol is present, the processor is further operable to increment the incrementing symbol while maintaining at least the initial position of the incrementing symbol in the game grid during a subsequent game event.

### BRIEF DESCRIPTION OF THE DRAWINGS

FIG. 1 is a diagram of a gaming machine according to embodiments of the invention.

FIGS. 2A, 2B, 2C, 2D, 2E and 2F are detail diagrams of a display of a gaming device showing a game progression according to embodiments of the invention.

FIGS. 3A, 3B, and 3C are detail diagrams of a display of a gaming device showing another game progression according to embodiments of the invention.

FIGS. 4A, 4B, and 4C are detail diagrams of a display of a gaming device showing another game progression according to embodiments of the invention.

FIG. 5 is a block diagram illustrating a computing arrangement according to embodiments of the invention.

FIG. 6 is a flow diagram illustrating a method of operating a gaming device according to embodiments of the invention.

FIG. 7 is a flow diagram illustrating another method of operating a gaming device according to embodiments of the invention.

FIG. 8 is a flow diagram illustrating another method of operating a gaming device according to embodiments of the invention.

FIGS. 9A, 9B, 9C, 9D, 9E, 9F, 9G, and 9H are diagrams of a gaming display illustrating example game play according to embodiments of the invention.

FIGS. 10A, 10B, 10C, 10D, 10E, 10F, 10G, and 10H are diagrams of a gaming display illustrating example game play according to embodiments of the invention.

FIGS. 11A, 11B, 11C, 11D, 11E, 11F, 11G, and 11H are diagrams of a gaming display illustrating example game play according to embodiments of the invention.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those object (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatus.

In various embodiments of the invention, the gaming displays are described in conjunction with the use of data in the form of “symbols.” In the context of this disclosure, a “symbol” may generally refer at least to a collection of one or more arbitrary indicia or signs that have some conventional significance. In particular, the symbol represents values that can at least be used to determine whether to award a payout. A symbol may include numbers, letters, shapes, pictures, textures, colors, sounds, etc., and any combination therebetween. A win can be determined by comparing the symbol with another symbol. Generally, such comparisons can be performed via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for enhancing winning result opportunities in gaming activities by providing an incrementing feature. The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. slot game) are provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that utilizes operations of an incrementing feature to enhance the game play on gaming devices. In one embodiment, a gaming device includes a display showing a game grid and a processor, where the processor is operable to receive a wager on a gaming event, determine an outcome for the gaming event, and determine if an incrementing symbol is present on a game grid when the determined game outcome is shown on the display. When the incrementing symbol is present, the processor is further operable to increment the incrementing symbol while maintaining at least the initial position of the incrementing symbol in the game grid during a subsequent game event.

Numerous variations are possible using these and other embodiments of the inventive concept. Some of these embodiments and variations are discussed below with reference to the drawings. However, many other embodiments and variations exist that are covered by the principles and scope of this concept. For example, although some of the embodiments discussed below involve reel-based slot machine examples of this concept, other embodiments include application of these inventive techniques in other types of slot games, poker games, or other games of chance. Some of these other types of embodiments will be discussed below as variations to the examples illustrated. However, many other types of games can implement similar techniques and fall within the scope of this inventive concept.

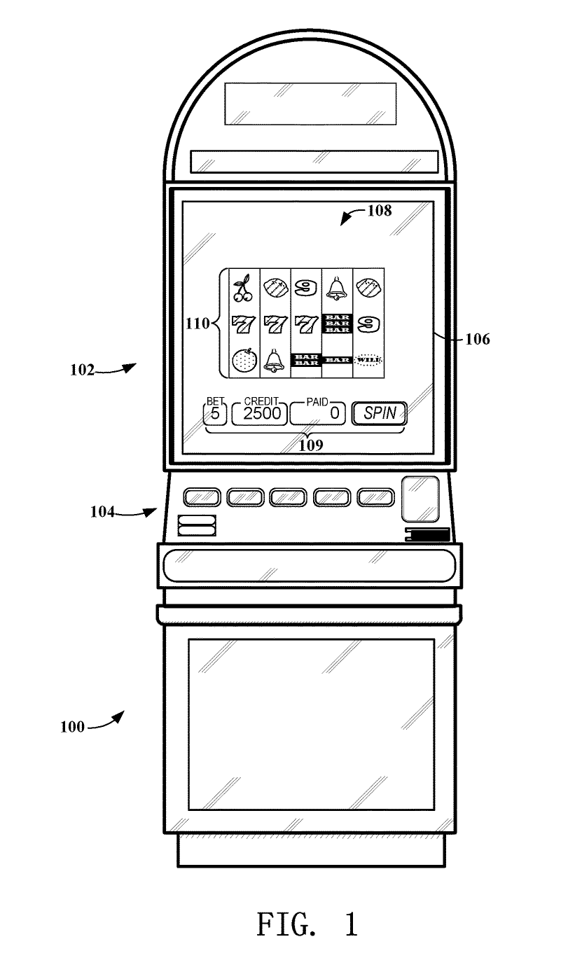

Referring to the example gaming apparatus 100 shown in FIG. 1, the gaming apparatus includes a display area 102 (also referred to as a gaming display), and a player interface area 104, although some or all of the interactive mechanisms included in the user interface area 104 may be provided via graphical icons used with a touch screen in the display area 102 in some embodiments. The display area 102 may include one or more game displays 106 (also referred to as “displays” or “gaming displays”) that may be included in physically separate displays or as portions of a common large display. Here, the game display 106 includes a primary game play portion 108 that displays game elements and symbols 110, and an operations portion 109 that can include meters, various game buttons, or other game information for a player of the gaming device 100.

The user interface 104 allows the user to control and engage in play of the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, or any other user input system or mechanism that allows the user to play the particular gaming activity.

The user interface 104 may allow the user or player to enter coins, bills, or otherwise obtain credits through vouchers, tokens, credit cards, tickets, etc. Various mechanisms for entering such vouchers, tokens, credit cards, coins, tickets, etc. are known in the art. For example, coin/symbol input mechanisms, card readers, credit card readers, smart card readers, punch card readers, radio frequency identifier (RFID) readers, and other mechanisms may be used to enter wagers. It is through the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as paytable information associated with a glass/plastic panel on the gaming machine 100 and/or graphical images. The symbols or other indicia associated with the play of the game may be presented on an electronic display device or on mechanical devices associated with a mechanical display. Generally, the display 106 devotes the largest portion of viewable area to the primary gaming portion 108. The primary gaming portion 108 is generally where the visual feedback for any selected game is provided to the user. The primary gaming portion 108 may render graphical objects such as cards, slot reels, dice, animated characters, and any other gaming visual known in the art. The primary gaming portion 108 also typically informs players of the outcome of any particular event, including whether the event resulted in a win or loss.

In some the example embodiments illustrated herein, the primary gaming portion 108 may display a grid (or equivalent arrangement) of game elements 110 or game element positions (also referred to as “reel stop positions” herein). As illustrated in the embodiment shown in FIG. 1, the grid includes three rows and five columns of game elements 110, which may form a game outcome of a game play event from which prizes are determined. In some slot machine examples, each column may display a portion of a game reel. The game reels may include a combination of game symbols in a predefined order. In mechanical examples, the game reels may include physical reel strips where game symbols are shown in images fixed on the reel strips. Virtual reel strips may be mapped to these physical reel positions shown on the reel strips to expand the range or diversity of game outcomes. In video slot examples, reel strips may be encoded in a memory or database and virtual reels may be used for the game reels with images representing the data related to the reel strips. In other slot machine embodiments, each reel stop position on the grid may be associated with an independent reel strip. In yet other slot machine embodiments, reels and/or reel strips may not be used at all in determining the symbols shown in the game element positions of the grid. For example, a symbol may be randomly selected for each game element position, or the symbols may be determined in part by game events occurring during game play, such as displayed elements being replaced by new game elements or symbols. Numerous variations are possible for implementing slot-type game play.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual symbols, or user controls over stopping or spinning reels. The game display 106 of the display area 102 may include other features that are not shown, such as paytables, navigation controls, etc.

As mentioned above, embodiments of this concept include an incrementing feature that increments or progresses between game events or game stages within a single game event. In one example, a special “wild” symbol that lands on a game grid expands (increments in size) in at least one subsequent game event. Thus, for example, a wild may be locked or main its location on the game grid from the first game event to the second game event, but may expand in the second game event to cover one other grid position adjacent to its original grid position for the second game event. The game events may be individual games of chance that have different wagers placed for each game event, or may be part of a free games bonus, where each game event is a separate free game within the bonus event. In yet other embodiments, the subsequent game events may be bonus game events that do not require additional wagers. For example, a wager may be placed on a first gaming event. If an incrementing symbol does not appear on the game grid as part of the outcome of the first gaming event, the first gaming event merely ends and the gaming device waits for additional inputs from the player. However, if an incrementing symbol appears on the game grid as part of the first gaming event (or another triggering condition), the incrementing symbol may be incremented and a second gaming event may be triggered without requiring an additional wager. In some embodiments, the wild symbol may continue to expand until it reaches an edge of the grid, or may continue to expand for a predetermined number of subsequent game events.

In other embodiments, the incrementing feature may increment in value (such as multiplier value for a wild or other symbol), increment in position (for example, move to the left without expanding), increment in symbol importance (for example, increment from a minor symbol to a major symbol, to a scatter symbol, to a wild symbol, to a bonus symbol), or may increment in any other manner over multiple game events.

The incrementing feature may be triggered by a special predefined symbol landing on the grid, may be triggered by one or more predefined symbols landing in a particular location on the grid, may be triggered at random, or may be triggered using a combination of the above criteria. In one example, a 5×5 game grid may be used with 5 spinning reels passing through the game grid. If a wild symbol lands on any reel in the third row of the grid (middle position horizontally), it acts as a wild for that spin. In the next spin, it locks into place and expands to cover the second, third, and fourth rows of its associated reel. On the third spin, the wild expands again to cover the entire reel (i.e., rows 1-5 of the associated reel). On the fourth spin, the wilds would disappear and the game would play as it did in the first spin where no symbols were locked into place on the game grid.

Although the above example, allows for a two-way expansion when a predefined symbol landed in a particular grid location, many variations are possible. In some embodiments, the symbols only increment by expanding in one predefined direction, such as down. Thus, a wild symbol landing in the first row (top) of a reel would expand down for another four games on a 5×5 grid. However, a wild landing on the bottom row would not expand or have any effect on a subsequent game. In another embodiment, a game may include a regular wild, and a special wild having a direction pointer and value. These special wilds may lock into place and expand in the direction indicated by the direction pointer for a number of gaming events equal to the value associated with the special symbol.

In other embodiments, a special symbol may be incremented in value. For example, a wild landing in the middle row of the third reel, may increment in a multiplier value for a predetermined or random number of times. For example, upon landing in the third row of the third reel, a processor associated with the gaming device may randomly determine that the wild will increment for next the 5 games. This information may be displayed to the player, or may remain a mystery to the player. Thus, over the next 5 games the multiplier may increment from 1× to 2× to 3× . . . 6×. In other embodiments, the value may be incremented in a non-linear, or even a partially random manner.

In yet other embodiments that include multiple game grids, the incrementing process may be incremented on the different game grids. Thus, a special symbol landing in the first game grid of a gaming event may be copied and expanded (or otherwise incremented) in the second game grid. This may continue for as many game grids as appear on the game display simultaneously. Thus, in a game display showing four separate game grids, a special symbol landing in the first game grid may be copied over to a corresponding location in the second game grid and expanded to cover at least one more grid position. Then the expanded special symbol from the second grid may be copied over to corresponding grid locations in the third game grid and again expanded by one or more positions. This process may repeat itself from the third game grid to the fourth game grid. Although the above example is discussed in terms of the size-increments (expanded symbol positions on the game grid), other embodiments use similar techniques to increment a multiplier value on a special symbol that appears on the game grids. This may or may not include copying the special symbol between game grids. In one example that does not use symbol position copying, a wild landing in the first game grid may be worth 1×. If a wild does land in the first game grid, then the sum of them, if more than one, is added to a multiplier value for any wilds appearing in the second game grid. For example, if 2 wilds were received in the first game grid, any wilds landing in the second game grid would be worth “3×.” This technique could continue for any number of game grids present in the game.

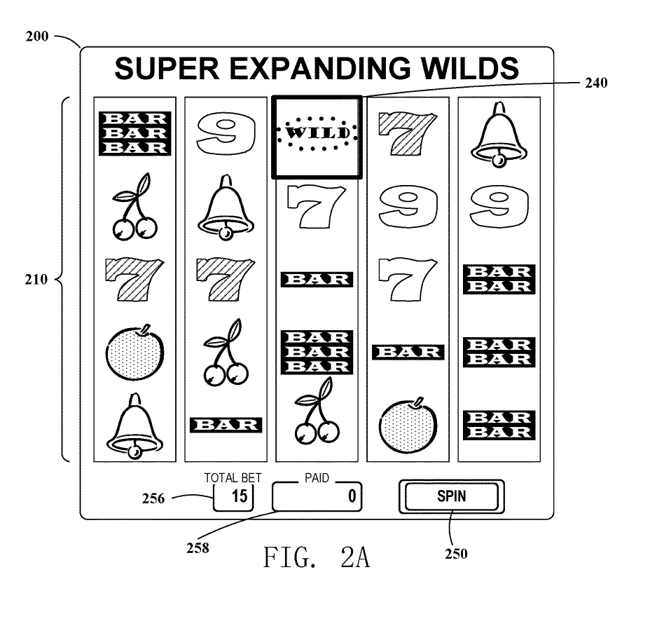

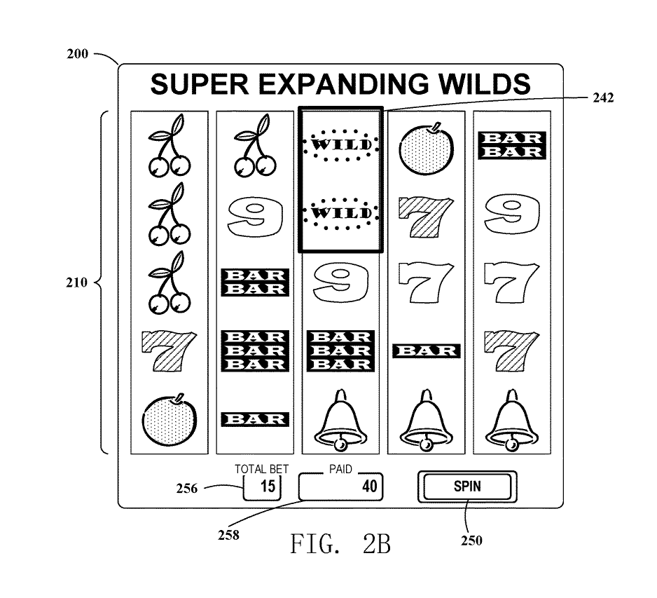

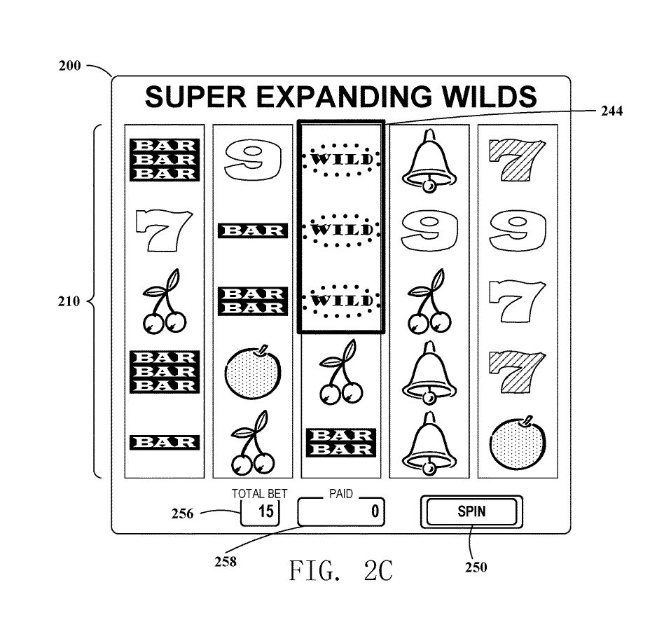

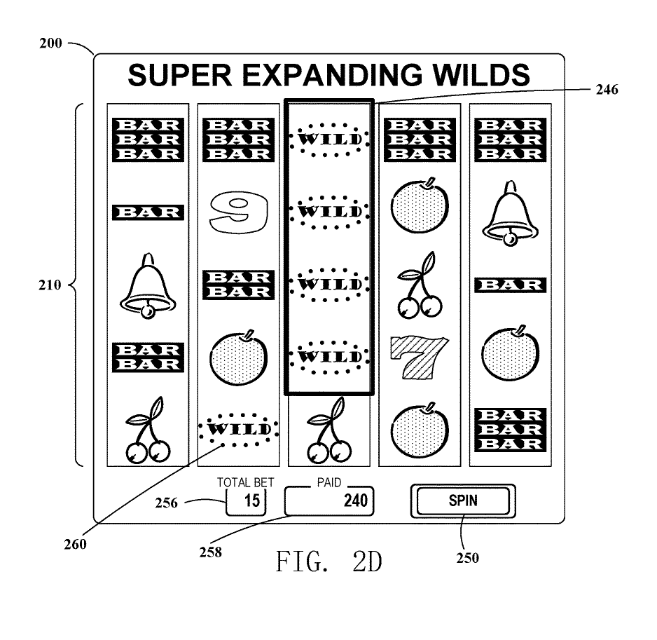

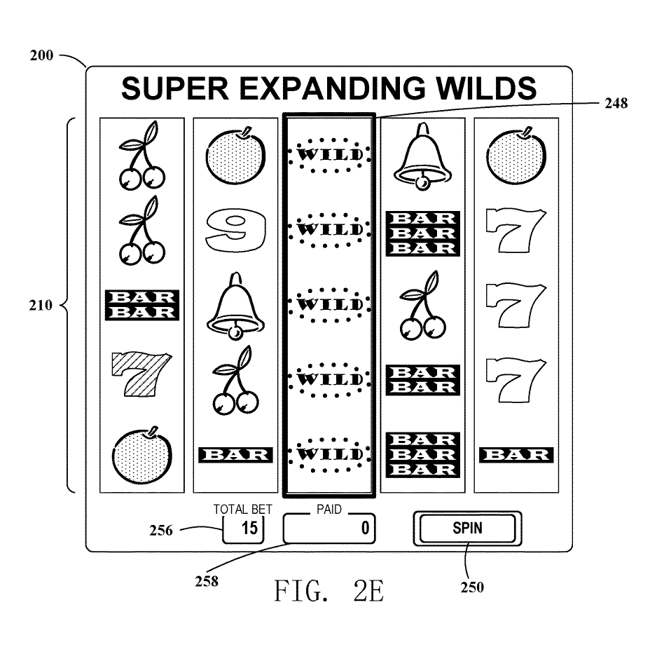

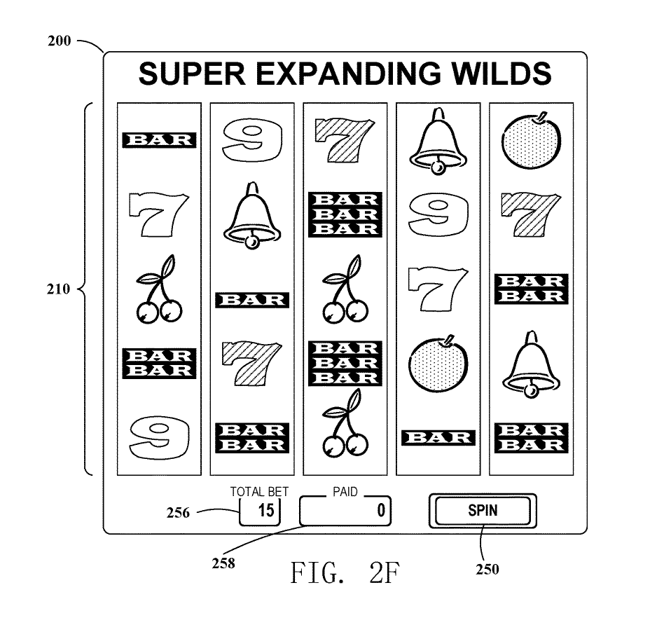

FIGS. 2A-2F, 3A-3C, and 4A-4C illustrate game progressions showing some of the embodiments discussed above.

Referring to FIGS. 2A-2F, if a wild symbol is received on the game grid, that wild is locked for a next game event and expanded one step down (i.e., copied to the adjacent symbol position below the locked wild symbol) until it reaches a bottom edge of the game grid. In particular, a game display 200 includes a game grid 210 of symbol positions where game reels spin through the game grid during play of the gaming event. The game display 200 may also include a player interface that includes meters and buttons to convey information about the game to the player and allow the player to interaction with the gaming device. For example, the game display 200 illustrated in these figures includes a total bet meter 256, an award meter 258, and “SPIN” button 250, although additional player interface elements may be present in other embodiments. Referring to FIG. 2A, a gaming event is played and an incrementing symbol 240 is part of the game outcome that is displayed on the game grid 210. As shown in FIG. 2B, the incrementing symbol 240 is copied or expands to replace the adjacent symbol below it and form a locked incrementing symbol 242 that is fixed on the game grid 210 during a second gaming event. FIG. 2C, shows a third game event where the locked incrementing symbol 244 again increments or expands to the next adjacent symbol position in the game grid.

This process is repeated in a fourth gaming event shown in FIG. 2D, where the locked incrementing symbol 246 again increments or expands in the game grid 210. As can be seen in FIG. 2D, if another wild lands on the bottom position of the game grid, it does not get locked or expanded in subsequent games. In other embodiments, only specially marked wilds may lock and expand. In yet other embodiments, wilds only lock and expand if no other wilds are currently locked on the game grid. In FIG. 2E, the locked incrementing symbol 248 again increments or expands to an adjacent symbol position in the game grid 210 for a fifth gaming event. Here, since the incremented symbol 248 has reached an edge of the game grid 210 (i.e., it reaches a symbol position that has a game grid edge opposite from where the symbol has been copied from), the locked incrementing symbol 248 will be removed for the next or sixth gaming event as shown in FIG. 2F.

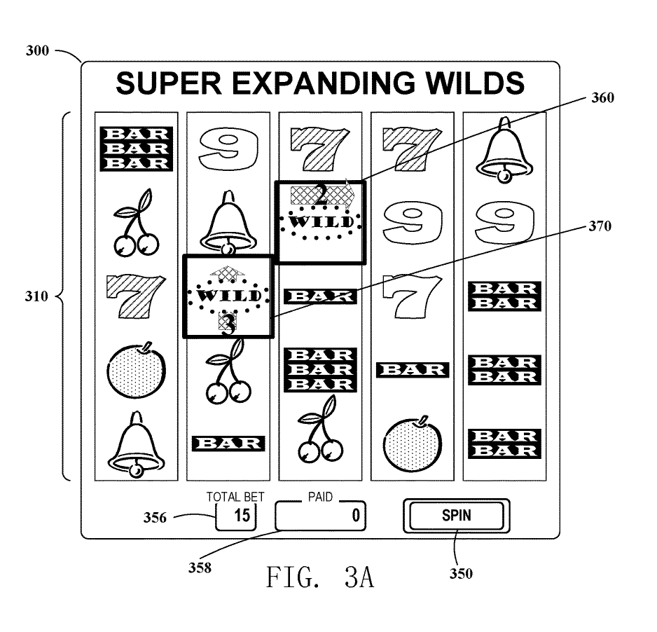

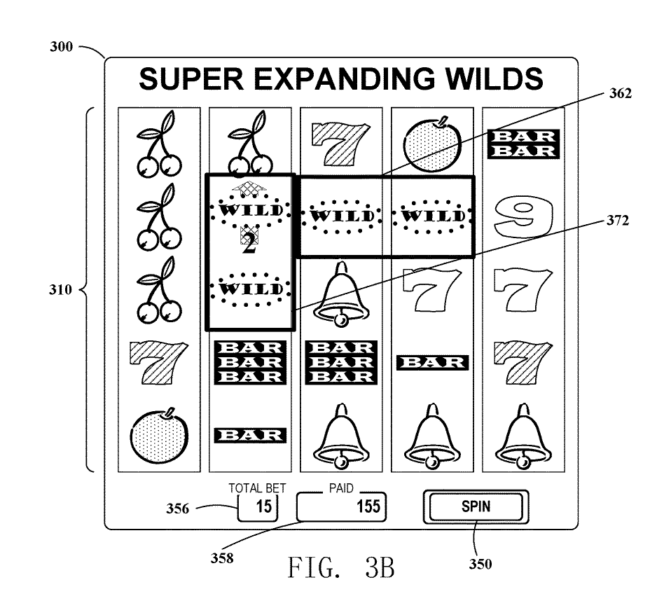

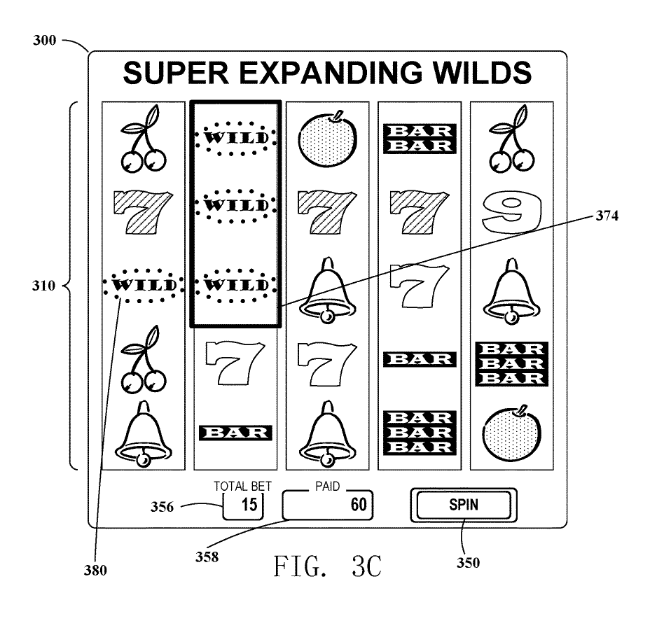

Referring to FIGS. 3A-3C, special wild symbols with an arrow and value are locked and expanded in the direction of the arrow for the number of games indicated by the value. In particular, a game display 300 includes a game grid 310 of symbol positions where game reels spin through the game grid during play of the gaming event. The game display 300 may also include a player interface that includes meters and buttons to convey information about the game to the player and allow the player to interaction with the gaming device. For example, the game display 300 illustrated in these figures includes a total bet meter 356, an award meter 358, and “SPIN” button 350, although additional player interface elements may be present in other embodiments. Referring to FIG. 3A, two special wilds are received 360, 370 where one of the symbols indicates that it will be alive for 3 games and expand in an upward direction (wild 360) while the other indicates that it will be alive only for the current game and next game while expanding to the right (wild 370). These directional indicators and incremental values associated with the incrementing symbols 360, 370 will be used to characterize how the incrementing symbols behave in the subsequent gaming events. As shown in FIG. 3B, the wilds 362, 372 have expanded in the direction indicated by the directional arrows. In FIG. 3C, only the vertically expanding wild 374 is left since it was alive for three games, while the horizontally expanding wild (370 in FIG. 3A) has been removed as it has exceeded the two games specified by the original value associated with it. These values may be predetermined and placed on the reel strips, or may be determined at random when the special wild lands. Similarly, the directional indicators/arrows may have predetermined directions, or the directions may be determined at random when the special wild lands. Note also in FIG. 3C that a non-special wild 380 is received, but does not have a direction or value associated with it. Thus, this wild 380 will not lock and increment in the next game event.

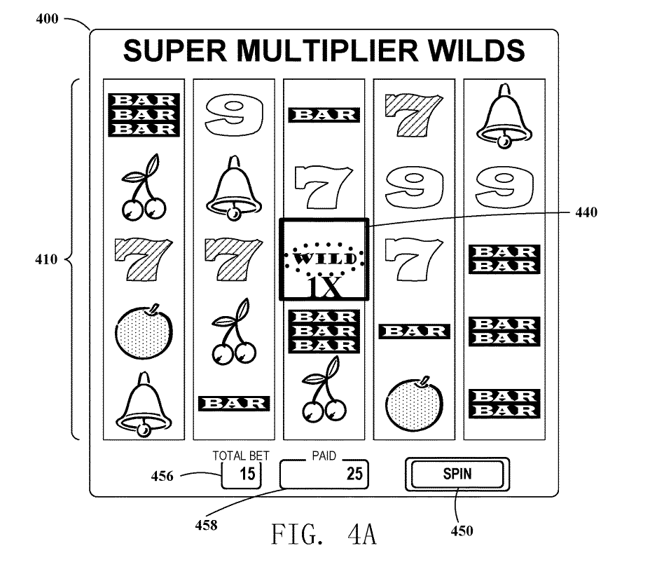

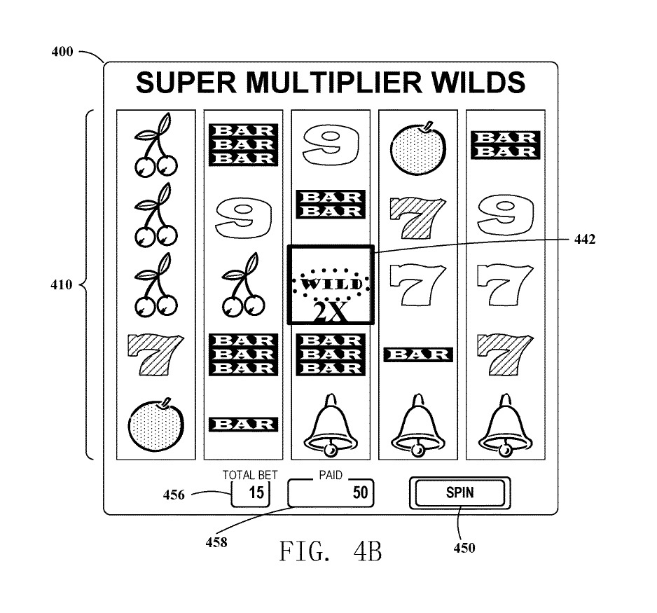

Referring to FIGS. 4A-4C, a wild 440 landing in the middle row of any reel will lock and increment in multiplier value for a randomly chosen number of gaming events. In this illustrated example, the wild is locked and the multiplier value is incremented over the next two games. Thus, it reaches a value of “3×” before going away for the fourth game in the series (the third game after it was received). In particular, a game display 400 includes a game grid 410 of symbol positions where game reels spin through the game grid during play of the gaming event. The game display 400 may also include a player interface that includes meters and buttons to convey information about the game to the player and allow the player to interaction with the gaming device. For example, the game display 400 illustrated in these figures includes a total bet meter 456, an award meter 458, and “SPIN” button 450, although additional player interface elements may be present in other embodiments. As shown in FIG. 4A, the incrementing symbol 440 is received during a first gaming event with a multiplier value of “1×.” Hence, any winning symbol combinations that use the incrementing symbol will be multiplied by the multiplier value, which in this case won't change the award amount.

Referring to FIG. 4B, the incrementing symbol 442 is now incremented to have a “2×” multiplier value for the second gaming event. Here, the three “cherry” pay of 25 credits is multiplied by the “2×” to pay 50 credits as shown in the Award meter 458. In FIG. 4C, the incrementing symbol 444 has its associated multiplier value incremented to “3×.” In this embodiment, as mentioned above, the maximum value for the incrementing multiplier is “3×”. However, in other embodiments, the maximum value of the multiplier may be randomly selected, based on other received symbols or game conditions, or simply be another predefined number. In other embodiments, the multiplier value may continue to increment until it is used to multiply an award for a symbol combination that includes the incrementing symbol. Additionally, while the multiplier value is shown as incrementing by “1×” for each gaming event, the multiplier value may by incremented in different manners, which may be predefined, or determined in part by symbols received on the game grid or other game conditions. Additionally, the initial multiplier value may be different from “1×,” and may be selected at random.

As discussed above, many different embodiments and variations are possible where a property of a symbol is incremented or stepped over multiple game events. Thus, while some embodiments have been shown or discussed in detail, many additional embodiments or variations are possible and fall within the scope and spirit of this invention.

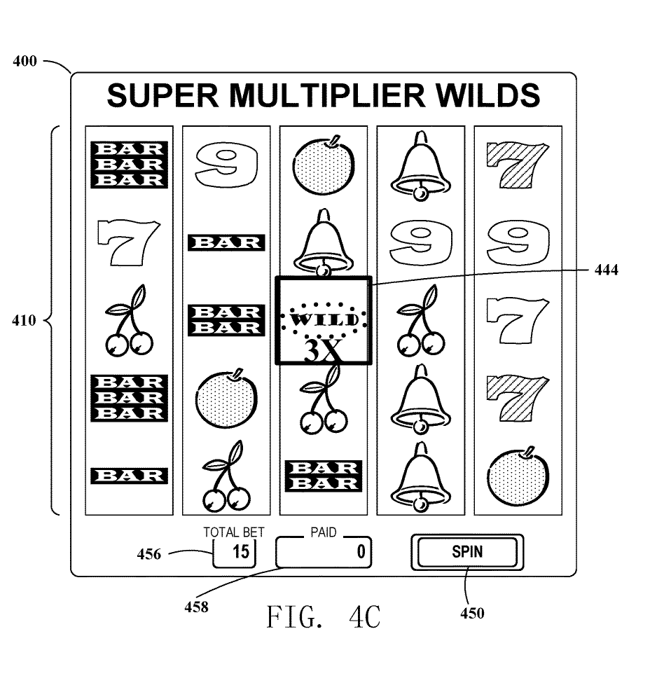

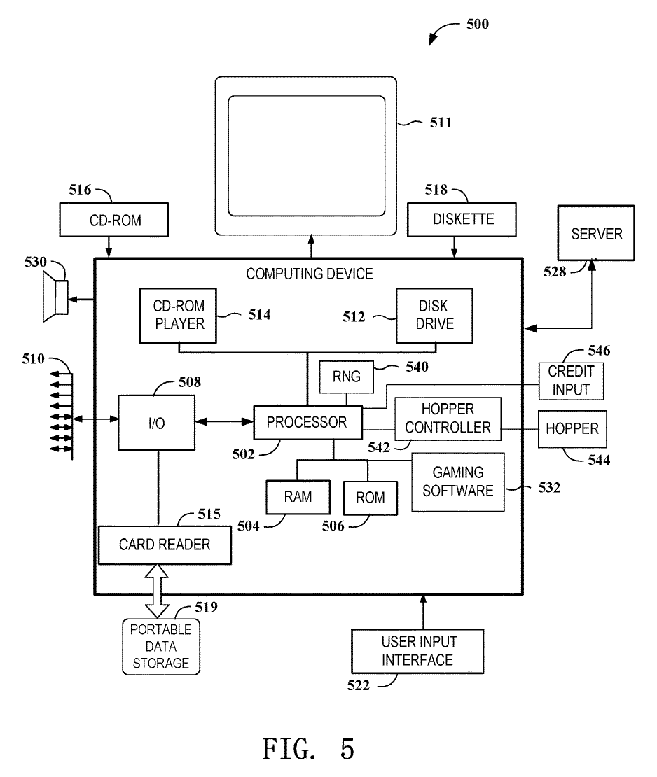

As may now be readily understood, one or more devices may be programmed to play various embodiments of the invention. The present invention may be implemented as a casino gaming machine or other special purpose gaming kiosk as described hereinabove, or may be implemented via computing systems operating under the direction of local gaming software, and/or remotely-provided software such as provided by an application service provider (ASP). The casino gaming machines utilize computing systems to control and manage the gaming activity. An example of a representative computing system capable of carrying out operations in accordance with the invention is illustrated in FIG. 5.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 500 of FIG. 5 is an example computing structure that can be used in connection with such electronic gaming machines, computers, or other computer-implemented devices to carry out operations of the present invention.

The example computing arrangement 500 suitable for performing the gaming functions in accordance with the present invention typically includes a central processor (CPU) 502 coupled to random access memory (RAM) 504 and some variation of read-only memory (ROM) 506. The ROM 506 may also represent other types of storage media to store programs, such as programmable ROM (PROM), erasable PROM (EPROM), etc. The processor 502 may communicate with other internal and external components through input/output (I/O) circuitry 508 and bussing 510, to provide control signals, communication signals, and the like.

The computing arrangement 500 may also include one or more data storage devices, including hard and floppy disk drives 512, CD-ROM drives 514, card reader 515, and other hardware capable of reading and/or storing information such as DVD, etc. In one embodiment, software for carrying out the operations in accordance with the present invention may be stored and distributed on a CD-ROM 516, diskette 518, access card 519, or other form of computer readable media capable of portably storing information. These storage media may be inserted into, and read by, devices such as the CD-ROM drive 514, the disk drive 512, card reader 515, etc. The software may also be transmitted to the computing arrangement 500 via data signals, such as being downloaded electronically via a network, such as the Internet. Further, as previously described, the software for carrying out the functions associated with the present invention may alternatively be stored in internal memory/storage of the computing device 500, such as in the ROM 506.

The computing arrangement 500 is coupled to the display 511, which represents a display on which the gaming activities in accordance with the invention are presented. The display 511 represents the “presentation” of the video information in accordance with the invention, and may be any type of known display or presentation screen, such as liquid crystal displays, plasma displays, cathode ray tubes (CRT), digital light processing (DLP) displays, liquid crystal on silicon (LCOS) displays, etc.

Where the computing device 500 represents a stand-alone or networked computer, the display 511 may represent a standard computer terminal or display capable of displaying multiple windows, frames, etc. Where the computing device is embedded within an electronic gaming machine, the display 511 corresponds to the display screen of the gaming machine/kiosk. A user input interface 522 such as a mouse, keyboard/keypad, microphone, touch pad, trackball, joystick, touch screen, voice-recognition system, etc. may be provided. The display 511 may also act as a user input device, e.g., where the display 511 is a touchscreen device. In embodiments, where the computing device 500 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG). The fixed and dynamic symbols generated as part of a gaming activity may be produced using one or more RNGs. RNGs as known in the art may be implemented using hardware, software operable in connection with the processor 502, or some combination of hardware and software. The present invention is operable using any known RNG, and may be integrally programmed as part of the processor 502 operation, or alternatively may be a separate RNG controller 540.

The computing arrangement 500 may be connected to other computing devices or gaming machines, such as via a network. The computing arrangement 500 may be connected to a network server 528 in an intranet or local network configuration. The computer may further be part of a larger network configuration as in a global area network (GAN) such as the Internet. In such a case, the computer may have access to one or more web servers via the Internet. In other arrangements, the computing arrangement 500 may be configured as an Internet server and software for carrying out the operations in accordance with the present invention may interact with the player via one or more networks. The computing arrangement 500 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 500 may also include a hopper controller 542 to determine the amount of payout to be provided to the participant. The hopper controller may be integrally implemented with the processor 502, or alternatively as a separate hopper controller 542. A hopper 544 may also be provided in gaming machine embodiments, where the hopper serves as the mechanism holding the coins/tokens of the machine. The wager input module or device 546 represents any mechanism for accepting coins, tokens, coupons, bills, electronic fund transfer (EFT), tickets, credit cards, smart cards, membership/loyalty cards, etc., for which a participant inputs a wager amount. The wager input device 546 may include magnetic strip readers, bar code scanners, light sensors, or other detection devices to identify and validate physical currency, currency-based tickets, cards with magnetized-strips, or other medium inputted into the wager input device. When a particular medium is received in the wager input device 546, a signal may be generated establish or increase an available credit amount stored in the internal memory/storage of the computing device 500, such as in the RAM 504. Thereafter, specific wagers placed on games may reduce the available credit amount, while awards won may increase the available credit amount. It will be appreciated that the primary gaming software 532 may be able to control payouts via the hopper 544 and controller 542 for independently determined payout events.

Among other functions, the computing arrangement 500 provides an interactive experience to players via input interface 522 and output devices, such as the display 511, speaker 530, etc. These experiences are generally controlled by gaming software 532 that controls a primary gaming activity of the computing arrangement 500. The gaming software 532 may be temporarily loaded into RAM 504, and may be stored locally using any combination of ROM 506, drives 512, media player 514, or other computer-readable storage media known in the art. The primary gaming software 532 may also be accessed remotely, such as via the server 528 or the Internet.

The primary gaming software 532 in the computing arrangement 500 is shown here as an application software module. According to embodiments of the present invention, this software 532 provides a slot game or similar game of chance as described hereinabove. For example, the software 532 may present, by way of the display 511, representations of symbols to map or otherwise display as part of a slot based game having reels. However, in other embodiments, the principles of this concept may be applied to poker games or other types of games of chance. One or more aligned positions of these game elements may be evaluated to determine awards based on a paytable. The software 532 may include instructions to provide other functionality as known in the art and described herein, such as shown and described above and below.

In other embodiments, wild symbols that fall on the game grid during a gaming event under certain conditions will be assigned a multiplier. The wild symbol will be “sticky” (that is, remain on the game grid over multiple gaming events) as long as it retains a multiplier value above a predefined threshold. The sticky multiplier symbol will have the associated multiplier value increase each spin in the presence of an increment trigger. The sticky multiplier symbol will have the associated multiplier value decrease in each spin in the absence of an increment trigger. Once the wild has reached a 1× multiplier, and no increment trigger is present, the wild symbol will no longer be “sticky” and will spin away on the reels during the next gaming event.

In these embodiments, when a wild lands on the reels, the reels are checked for a triggering condition or mechanism. This triggering condition might be the presence of an activating symbol, an overlay, a symbol overlay, be based on a mystery trigger, or be associated with any other triggering mechanism or condition. If a triggering condition is satisfied, the wild symbol will be assigned a multiplier value in a range of 3-5×. The game grid will then be evaluated and paid out.

The wild symbol will then become sticky and remain in place on the game grid for the next spin. If the next spin also satisfies a trigger condition, the multiplier value assigned to the sticky wild will increment by some number, for example 1×. If the next spin does not satisfy a trigger condition, the multiplier value assigned to the wild will decrement by some number, for example 1×.

The wild symbol will remain sticky and on the reels as long as an end condition is not met. One example of an end condition would be when the wild symbol is no longer associated with a multiplier value (or a value of 1×) and no trigger condition is present in the gaming event. Another end condition could be the presence of a de-activating trigger during the gaming event.

In other embodiments, bonus symbols that fall on the reels in the presence of an increment trigger will be assigned a counter value. That counter will increase each spin in the presence of an increment trigger. It will decrease each spin in the presence of a decrement trigger. The bonus symbol will be sticky as long as it retains a counter value of greater than 0. If the counter reaches 1 and a decrement trigger is present, the bonus symbol will spin away with the reels.

In one example, a 5 reel gaming device includes game reels with bonus symbols on reels 3, 4, and 5. When a bonus symbol lands on the reels, it is determined whether the reels include an increment trigger. This mechanism might be an activating symbol, an overlay, a symbol overlay, a mystery trigger or any other mechanism deemed appropriate. If a trigger is present, a counter will be associated with the bonus symbol and will be assigned a value in the range of 2-5. The reels will then be evaluated and paid out.

The bonus symbol will become sticky and remain in place for the next spin. If the next spin also presents an increment trigger, the counter assigned to the wild will increment by some number, for example 1. If the next spin presents a decrement trigger, the counter assigned to the bonus symbol will decrement by some number, for example 1.

The bonus symbol will remain sticky and on the reels as long as an end condition is not met. One example of an end condition would be when the associated counter has reached a count of 1 and a decrement trigger is present on the reels. Another end condition could be the presence of a de-activating trigger on the reels. If bonus symbols are present on reels 3, 4 and 5, the bonus will be triggered and all bonus symbols will spin away with the next base game spin.

In other embodiments a feature includes a wild symbol with an active property that allows the wild symbol, under the right conditions, to obtain and increase an associated multiplier over a multi-game period. In some embodiments, the symbols do not always convert to the same improved symbol. Rather, in these embodiments, there may be some randomness in determining what the next and final multiplier will be, though it may be guaranteed to be equal (at max) or an improvement with each game under activation. The active-state wild symbol could be thought of to have four components: a currently active pay multiplier, a final multiplier, a multiplier increment rate, and a game duration. In one embodiment, these components may be equated to the following plant/flower properties so that they represent: current size, fully mature size, growth rate, and lifespan.

In some embodiments, these special wild symbols may be depicted as seeds, flowers in the early stages of growth, or very small groups of young flowers. At prescribed times when one or more of these symbols were selected for activation they would “bloom.” The condition for activation in this example could be the presence of a certain number of a water themed symbol. This activation would then have the effect of the flower symbols becoming sticky (persisting) and visibly maturing into lusher states with subsequent spins over the life span. The lusher states are accompanied by increased pay multipliers, up to a max. The extent and rate of flower blossoming and life span would be determined by some random calculations—similar to how plants actually grow. Some yields are better than others, especially under particular conditions. Although the player will always benefit from the process up to the maximum mature state, they may sometimes over the duration of bonus cycle receive, for example, a full rose 2× multiplier and for other activation periods something grander like a bouquet, for example, 5×. Beyond the maximum determined “yield” (max multiplier), the growth rate determines how quickly the blooming symbol proceeds to this mature state, that is how much the pay multiplier increases by with the next spin. The growth rate could be fixed or be randomly calculated with each game in the activation period. So, for example the mature multiplier could be determined to be 5×, the growth rate 1×, and the lifespan 5 games. This flower symbol would go to 2× upon activation and increase by 1 with each spin, up to 5× for the 5-game duration.

In other embodiments, this feature may be combined with overlay patterns or other game grid characteristics, whether predefined, random, or persistent, to increase the number of variables contributing to the bonus experience. For example, using a similar plant theme, it is possible that sunlight, water, and/or fertilizer overlays can be used to further activate or modify the flower symbols. The intersection of all overlay regions could have maximum blooming potential—for yield, growth rate, and lifespan. The symbol window with big blooming wins could then transform into a full flower bed or bountiful garden. Additional variations could include having different flowering symbol types and allow them to cross breed or a pollination mechanism to produce the wilds in the first place.

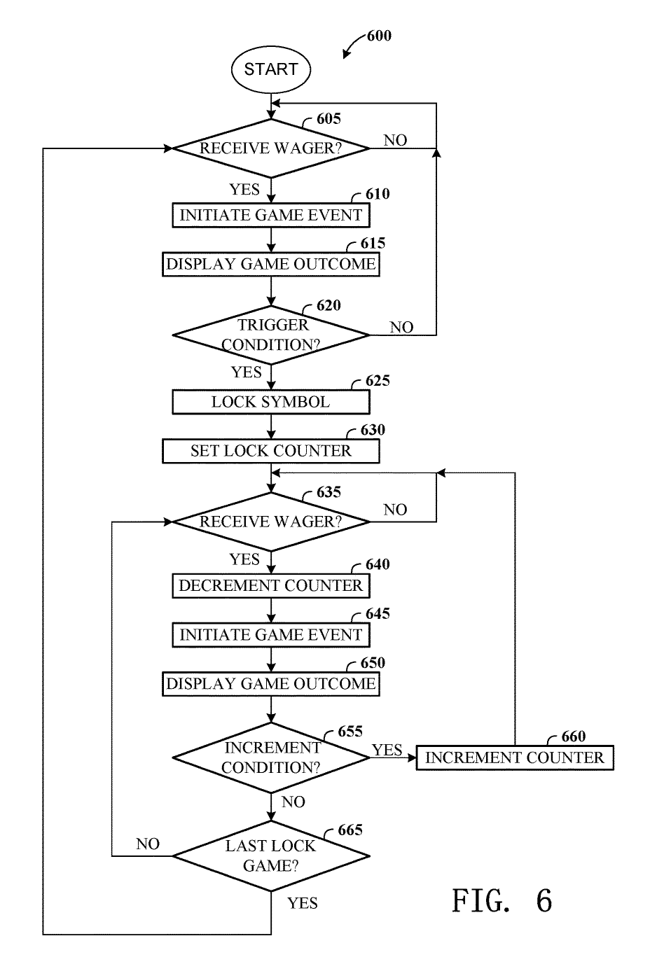

FIGS. 6, 7, and 8 are flow diagrams representing methods in which a gaming device and/or gaming system can be operated according to embodiments of the invention. Although various processes are shown in a particular order in these flow diagrams, the order of these processes can be changed in other embodiments without deviating from the scope or spirit of this concept. Hence, the order of the processes shown is for illustrative purposes only and is not meant to be restrictive. Additional game processes may also be included between various processes even though they are not shown in these flow diagrams for clarity purposes. Further each of the processes may be performed by components in a single game device, such as by a game processor, or may be performed in part or whole by a remote server or processor connected to the gaming device via a network. Each process may be encoded in instructions that are stored in a memory, a computer-readable medium, or another type of storage device. Note that these example methods are just some embodiments of how the steps of a game operation can be implemented. As discussed and shown above, many variations exist which may require additional, fewer, or different processes to complete.

Referring to FIG. 6, the flow 600 begins at process 605 where the gaming device checks to see if a wager has been received. Once a wager has been received on a game event in process 605, flow 600 progresses to process 610 where the gaming device initiates the game event. Here, the received wager may be deducted from a credit amount stored in a memory of the gaming device. After a gaming outcome is randomly determined by a processor in the gaming device, the game outcome is displayed on a gaming display as part of process 615. In process 620, it is determined whether a trigger condition is present to trigger a locked symbol.

In some embodiments, the presence of a predefined symbol (such as a wild symbol, bonus symbol, jackpot symbol, progressive symbol, etc.) in the game outcome satisfies the feature trigger condition. In other embodiments, the trigger condition may be based at least in part on receipt of a side wager, a sub-symbol, a symbol overlay, a random determination, a player's loyalty status, prior game results, a result of another game feature or bonus, etc. and/or a combination of the above. If the trigger condition is not satisfied in process 620, flow 600 returns to process 605 to await another wager or other player action. If the trigger condition is satisfied in process 620, flow 600 proceeds to process 625 where at least one symbol is locked on the symbol grid. The symbol locked may be the predefined symbol that satisfied the trigger condition in process 620, may be a different predefined symbol, or may be a random symbol that may or may not have to be present on the game grid as part of the game outcome. When a symbol is “locked,” the symbol may remain in the same position on the game grid for at least one additional game event. These “locked” symbols may also be referred to as “sticky” symbols since they stick to the grid position while the other symbols on the game reel (and other game reels) are spun or randomized to likely generate a different game outcome.

In process 630 a lock counter is set. The lock counter may be displayed on the game grid, such as in a counter display area or on the locked symbol, or the lock counter may not be displayed or communicated to the player. The number, amount, or count, used to set the lock counter may be based on the game outcome, may be chosen from a group of possible amounts, or may be random. The count may be associated with a number of games where the locked symbol remains locked, may be associated with a multiplier value, may be associated with another property of the locked symbol, may be based on the receipt of one or more different predefined symbols, may be based on an amount of time, or may use a combination of elements above. The lock counter may further be used to count up or count down. The lock counter may increment or decrement by a consistent amount or a random amount. The amount the lock counter increments or decrements may further be influenced by other received symbols during future game play, such as activator symbols or terminator symbols.

In process 635, it is determined whether another wager is received. This process may be similar to process 605 described above. When it is determined that a wager has been received in process 635, the flow 600 progresses to process 640, where the lock counter is decremented. Although process 640 specifies that the lock counter is decremented, in other embodiments the lock counter may be incremented in a similar process. Additionally, as mentioned above, the lock counter may be decremented (or incremented) in a variety of manners (such as by a predetermined amount, by a variable amount depending on one or more conditions, or by a random amount). In process 645, a second or subsequent game event is initiated. As with process 610, this process may include deducting the received wager from a credit amount stored in a memory of the gaming device. From a display perspective, the initiated game in process 645 may include holding the locked symbol in the same symbol position on the game grid while the game reels spin through the other symbol positions in the game grid. In process 650, the game outcome for the second game event is displayed on the gaming display.

In process 655, it is determined whether an increment condition is satisfied. In some embodiments, the increment condition may be satisfied when a predetermined symbol appears on the game grid as part of the displayed game outcome in process 650. In other embodiments, the increment condition may be based at least in part on receipt of a side wager, a sub-symbol, a symbol overlay, a random determination, a player's loyalty status, prior game results, a result of another game feature or bonus, etc. and/or a combination of the above. Although described here as an “increment” condition, whereby the counter is incremented in process 660 if the increment condition is satisfied, in other embodiments, this may be a decrement condition determination where the lock counter is decremented when the condition is satisfied. In yet other embodiments, there may be both increment conditions and decrement conditions where a lock counter can be incremented or decremented depending on which of the conditions are satisfied. In this illustrated embodiment, when the increment condition is satisfied, flow 600 proceeds to process 660 where the lock counter is incremented. In process 660, the lock counter may be incremented by a predetermined amount, may be incremented based on one or more variables, or may be incremented at random. After the lock counter has been incremented, flow 600 returns to process 635 to await another wager on a game event while maintaining the locked symbol.

If the increment condition is not satisfied, flow 600 proceeds to process 665 where it is determined whether the last game event was the last game where the symbol is locked.

Note that this example method is just one embodiment of how a game operation can be implemented. As discussed and shown above, many variations exist which may require additional, less, or different processes to complete. In some embodiments, this process includes determining if the lock counter has reached a predetermined threshold. In other embodiments, a symbol may be unlocked by a condition occurring during the game event. For example, if a terminator symbol is received during the game, the symbol may be unlocked in a subsequent game thereby ending the symbol lock feature. In another example, if the locked symbol is used in a symbol combination that pays an award, pays an award over a certain amount, pays a progressive award, triggers a bonus event, or otherwise is used in a beneficial way to the player, the lock feature may end. In some of the these embodiments, process 665 may precede process 655 where it does not matter if an increment condition is present if some other condition can end the locked symbol feature. If it is determined in process 665 that it is not the last lock game, flow 600 returns to process 635 to await another wager on a gaming event with the symbol remaining locked. On the other hand, if it is determined in process 665 that it is the last lock game, flow 600 returns to process 605 to await another wager on a gaming event with the symbol becoming unlocked.

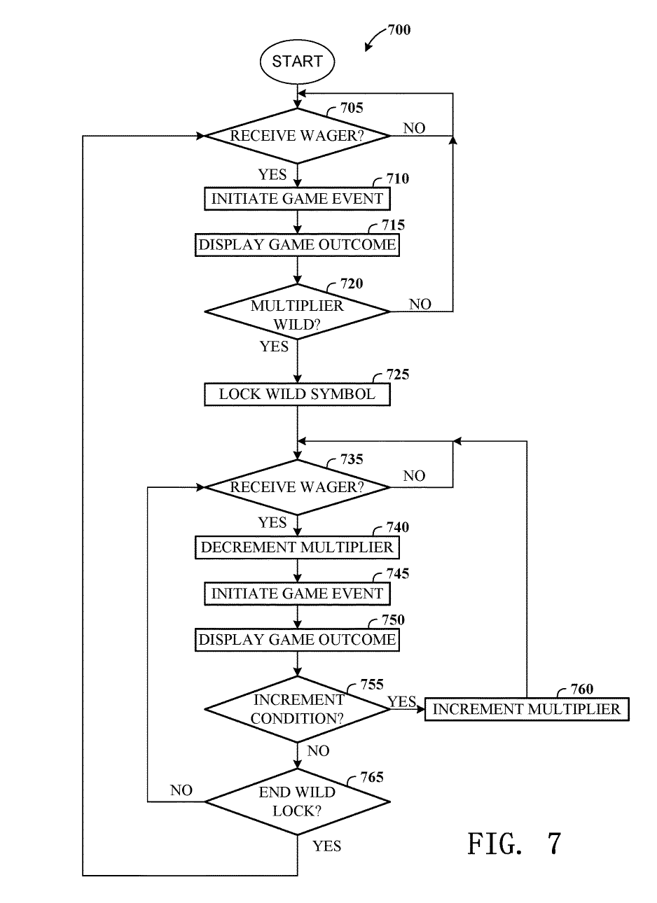

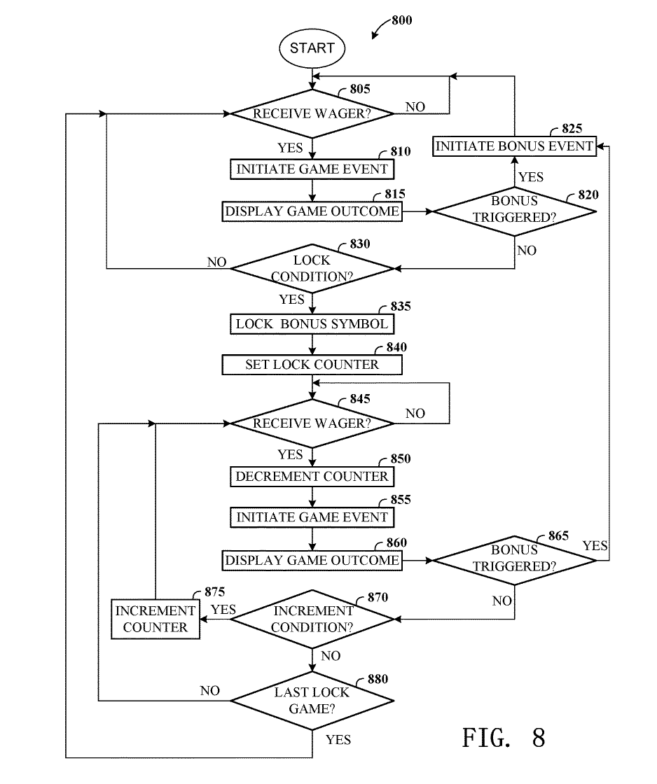

FIGS. 7 and 8 show additional example embodiments with specific parts to the locking symbol feature. In the embodiments illustrated in part by FIG. 7, the feature includes a locking wild symbol that is associated with a multiplier. Here, the multiplier value is randomly selected from a range of possible multiplier values. The wild symbol with the multiplier is locked and the multiplier is decremented by one for each subsequent game until it reaches “1×” (or no multiplier help), at which point it unlocks and spins away during the next game. In the embodiments illustrated in FIG. 8, the feature includes locking bonus symbols that are locked until a bonus is initiated, or a counter associated with a particular locked bonus symbol reaches a predetermined value (such as zero). Many of the processes illustrated in FIGS. 7 and 8 are similar to processes described above, especially with respect to FIG. 6. Since these processes have already been described in detail, most of these details will not be repeated when describing the similar processes in FIGS. 7 and 8 below.

Referring to FIG. 7, flow 700 begins at process 705 where it is determined if a wager has been received to initiate a game event. After a wager has been received, a first game event is initiated in process 710 and a determined outcome for the first game event is displayed in process 715. In process 720, it is determined whether a locking multiplier wild symbol is present on the game grid as a result of the first game outcome. If such as symbol is not present, flow 700 returns to process 705. On the other hand, if a locking multiplier wild symbol is present on the game grid as a result of the first game outcome, the multiplier wild symbol is locked on the game grid in process 725, and the gaming device waits for a wager to be placed on a second game event in process 735. When another wager has been received, a multiplier value of the locking wild symbol is decremented in process 740, a second game event is initiated in process 745, and a determined outcome for the second game event is displayed on the game display in process 750. If in increment condition is present based on the second game outcome as determined in process 755, the multiplier value of the locked wild is incremented by a predefined value, a variable value dependent on one or more conditions, or by a random amount. Here, the wild remains locked and the flow returns to process 735 to await a wager on a third gaming event. If an increment condition is not present in process 755, it is determined if the locking wild is to be unlocked in process 765. Here, a feature terminating condition, such as receipt of a terminator symbol, the use of the wild in an award over a threshold value, the multiplier reaching a “lx” or other value, or other end condition may be used in process 765 to determine if the wild symbol is to be unlocked for the next game event. If there is not a feature ending condition, flow 700 returns to process 735 to await a wager on a third game event with the multiplier wild still locked. On the other hand, if a feature ending condition is determined to be present in process 765, the multiplier wild is unlocked and flow 700 returns to process 705 to await a wager on another game event.

Referring to FIG. 8, flow 800 begins at process 805 where it is determined if a wager has been received to initiate a game event. After a wager has been received, a first game event is initiated in process 810 and a determined outcome for the first game event is displayed in process 815. In process 820, it is determined if a bonus event is triggered. If the bonus event was triggered during the first game event, a bonus event is initiated in process 825 and flow 800 returns to process 805 to await a wager on another game event. If a bonus is not triggered based on the first game outcome, flow 800 proceeds to process 830, where it is determined whether a locking bonus symbol is present on the game grid as a result of the first game outcome. If such as symbol is not present, flow 800 returns to process 805. On the other hand, if a locking bonus symbol is present on the game grid as a result of the first game outcome, the bonus symbol is locked on the game grid in process 835 and a lock counter associated with that particular locked bonus symbol is set in process 840. In other embodiments that bonus lock counter may be associated with any and all bonus symbols that are locked during a group of game events.

In process 845, the gaming device waits for a wager to be placed on a second game event. When another wager has been received, the lock counter is decremented in process 850, a second game event is initiated in process 855, and a determined outcome for the second game event is displayed on the game display in process 860. In process 865, it is determined if a bonus event is triggered. If the bonus event was triggered during the second game event, the bonus symbol becomes unlocked and a bonus event is initiated in process 825. If a bonus is not triggered based on the second game outcome, flow 800 proceeds to process 870, where it is determined whether an increment condition is present based on the second game event. If in increment condition is present based on the second game outcome as determined in process 870, the lock counter is incremented by a predefined value, a variable value dependent on one or more conditions, or by a random amount in process 875. Here, the bonus symbol remains locked and the flow 800 returns to process 845 to await a wager on a third gaming event. If an increment condition is not present in process 870, it is determined if the locking bonus symbol is to be unlocked in process 880. Here, a feature terminating condition, such as receipt of a terminator symbol, the use of the bonus symbol in triggering the bonus, the lock counter reaching a threshold value, or other end condition may be used in process 880 to determine if the bonus symbol is to be unlocked for the next game event. If there is not a feature ending condition, flow 800 returns to process 845 to await a wager on a third game event with the bonus symbol still locked. On the other hand, if a feature ending condition is determined to be present in process 880, the bonus symbol is unlocked and flow 800 returns to process 805 to await a wager on another game event.

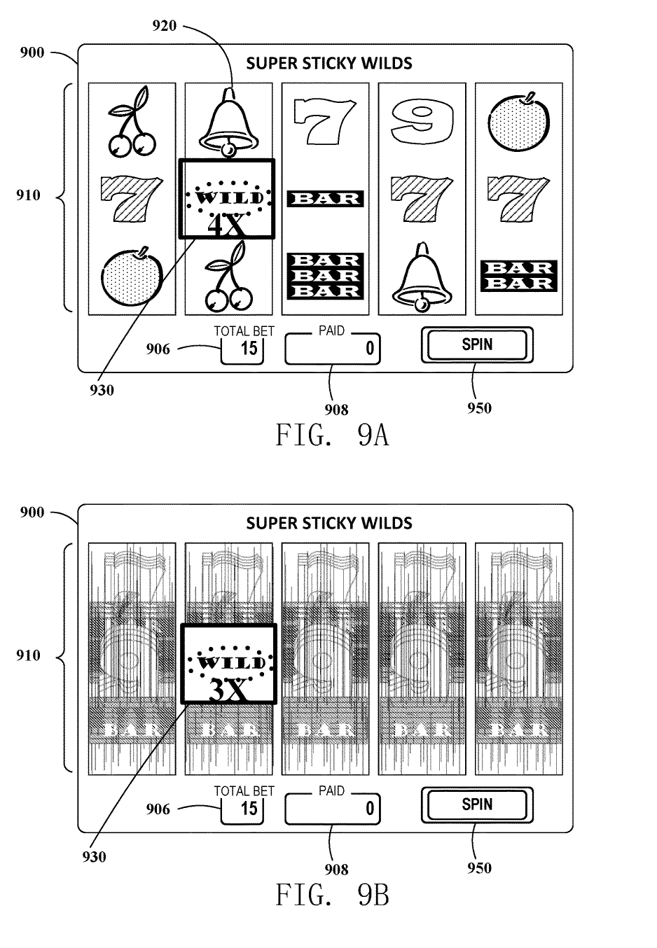

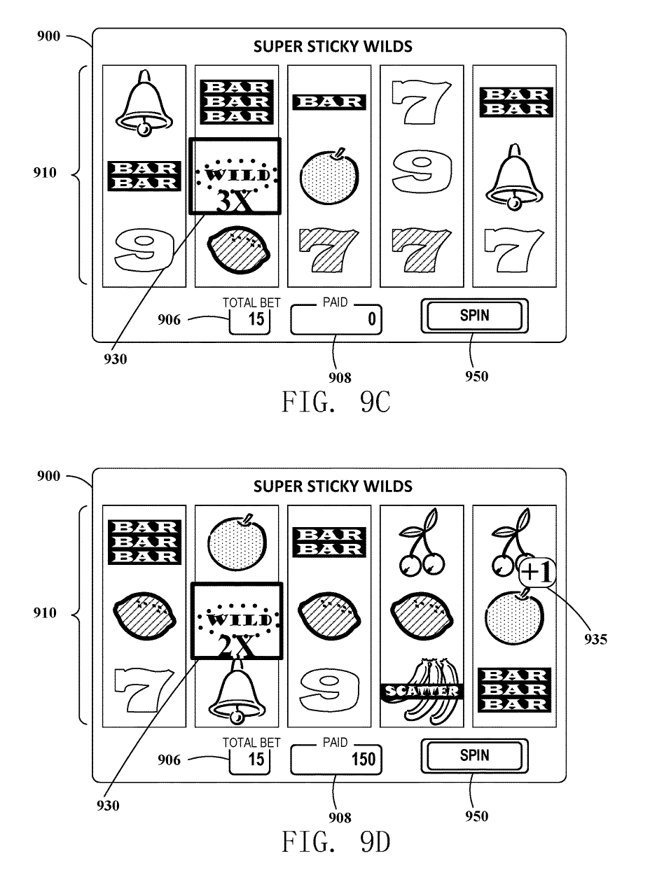

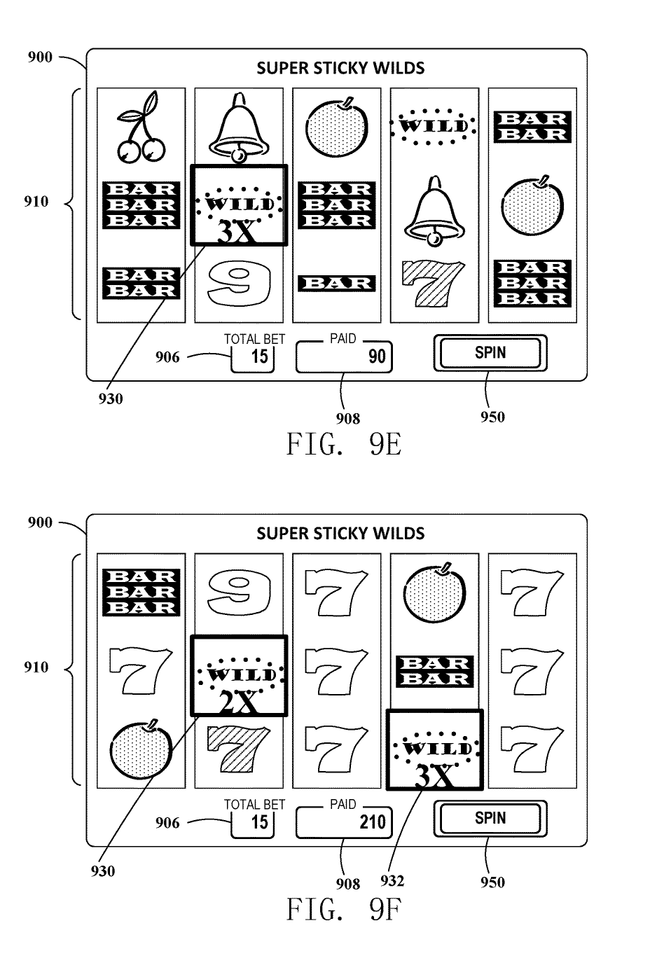

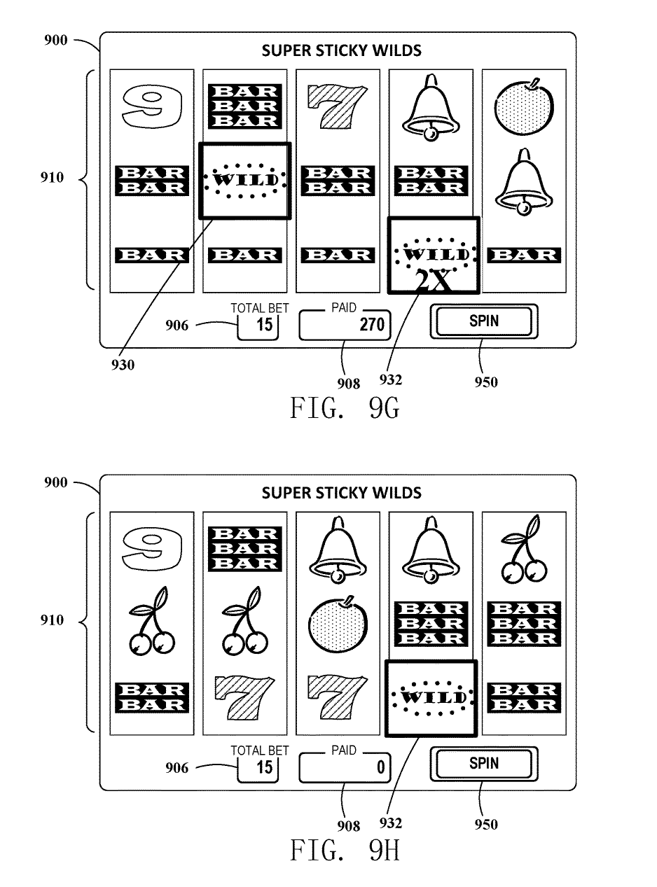

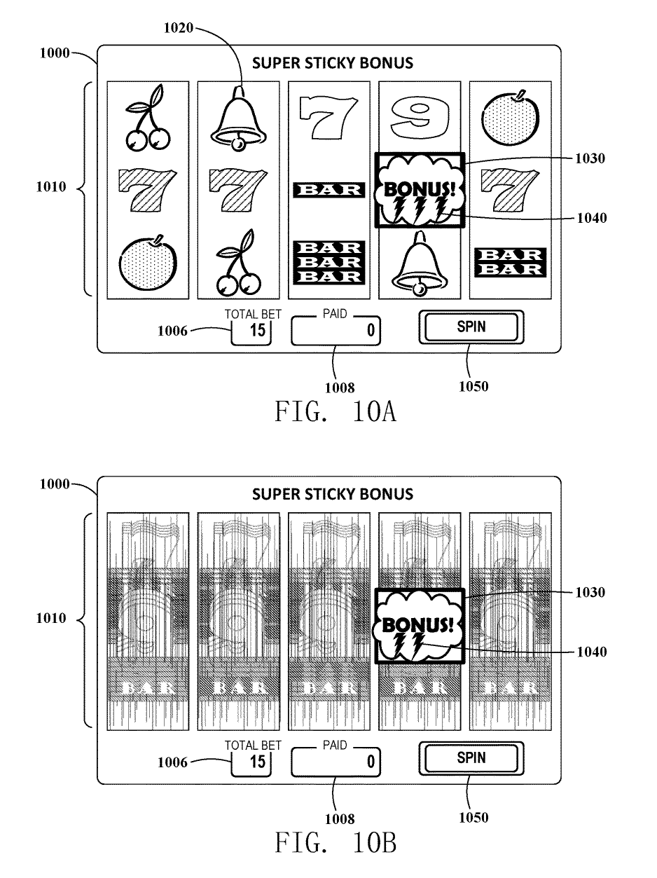

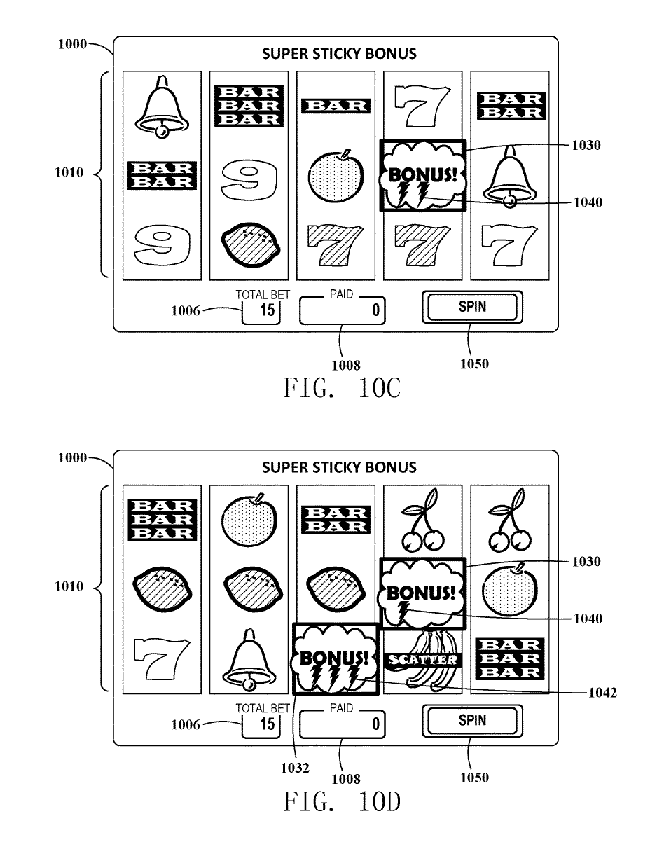

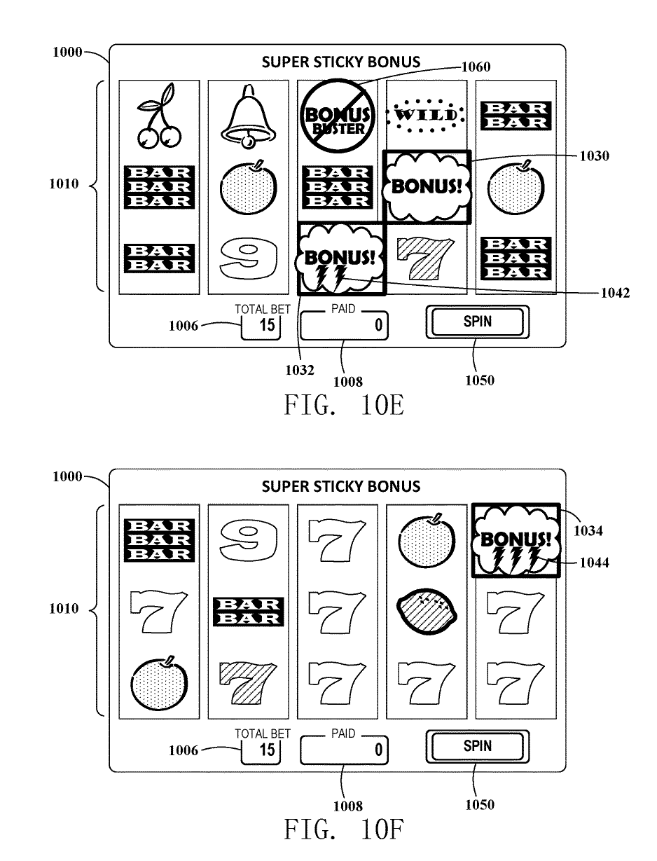

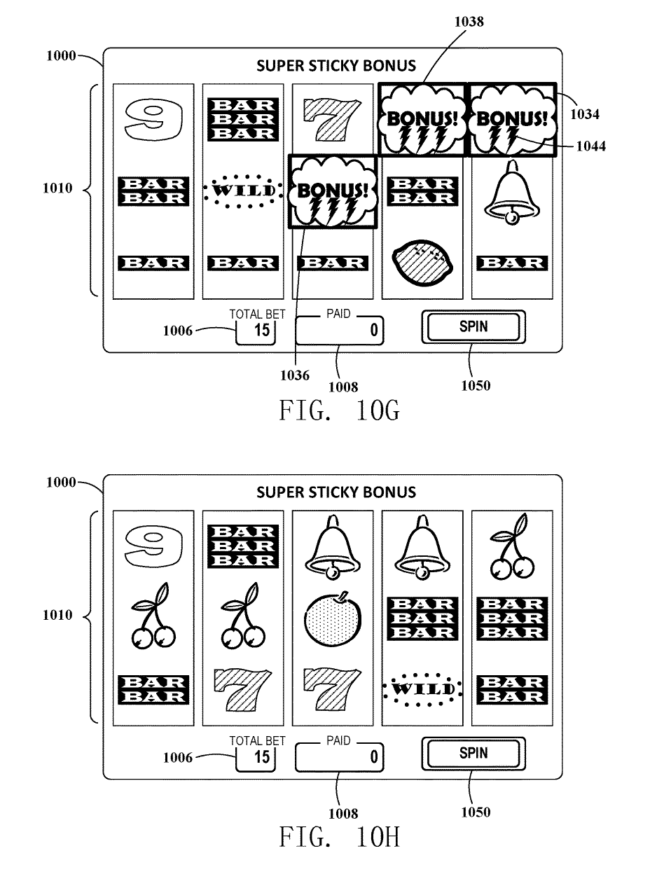

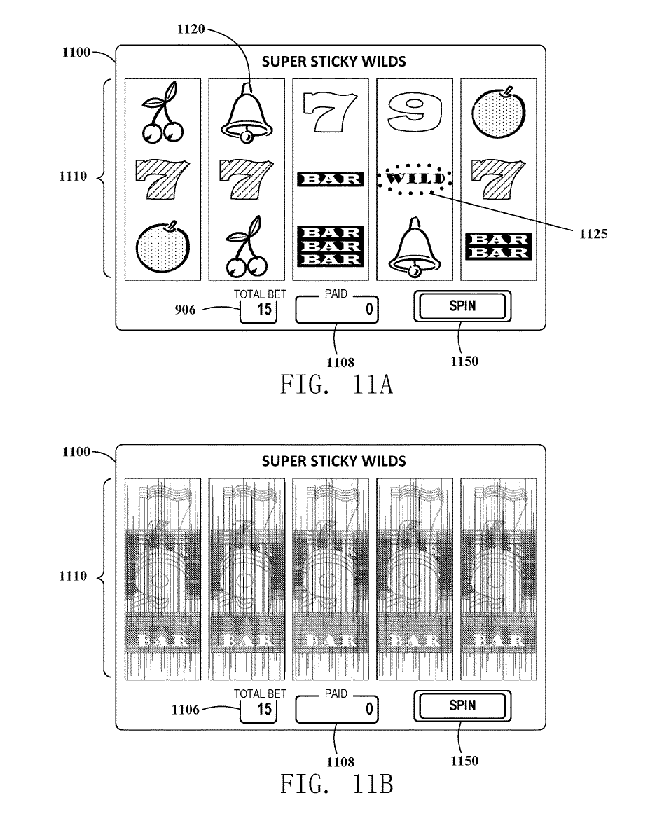

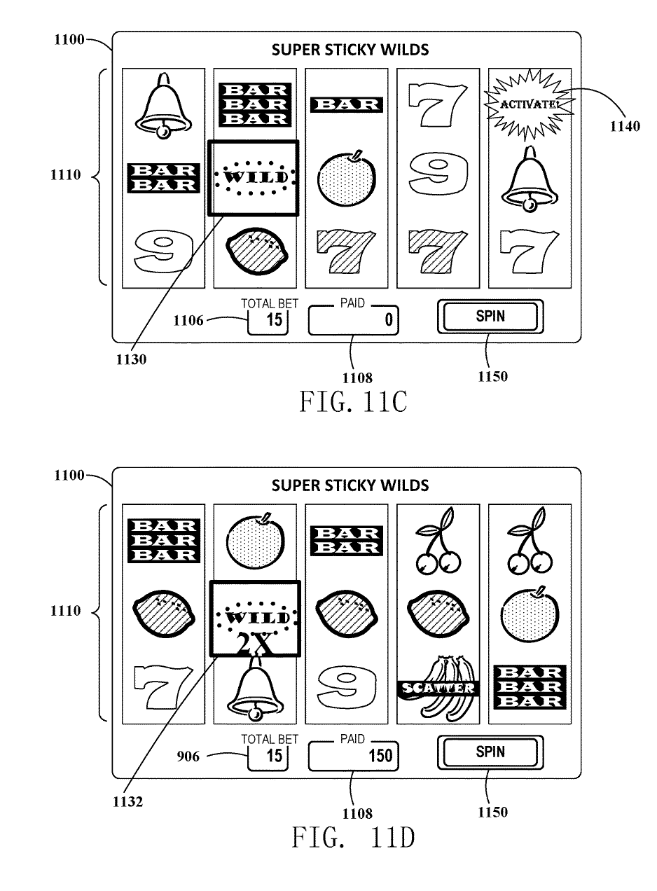

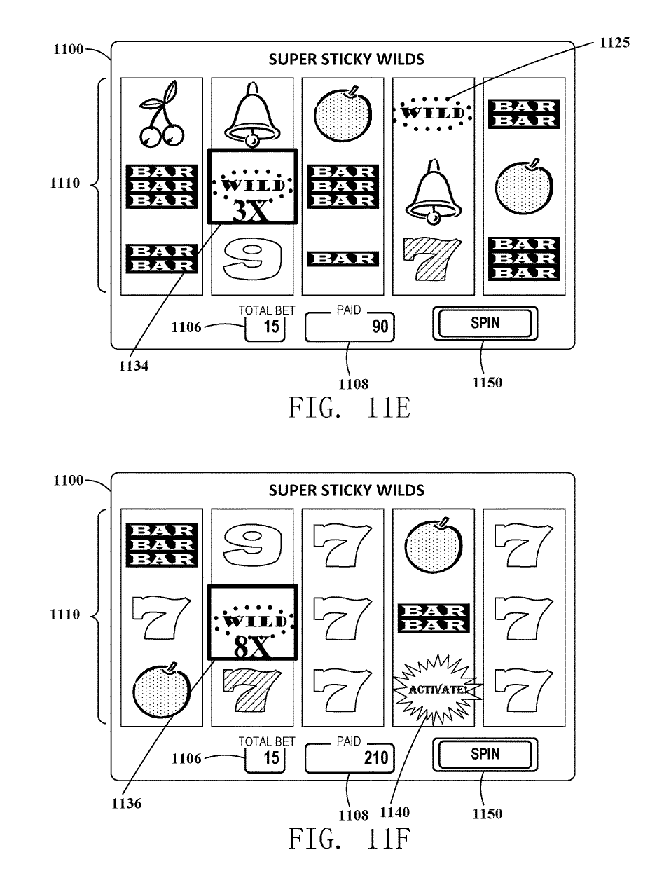

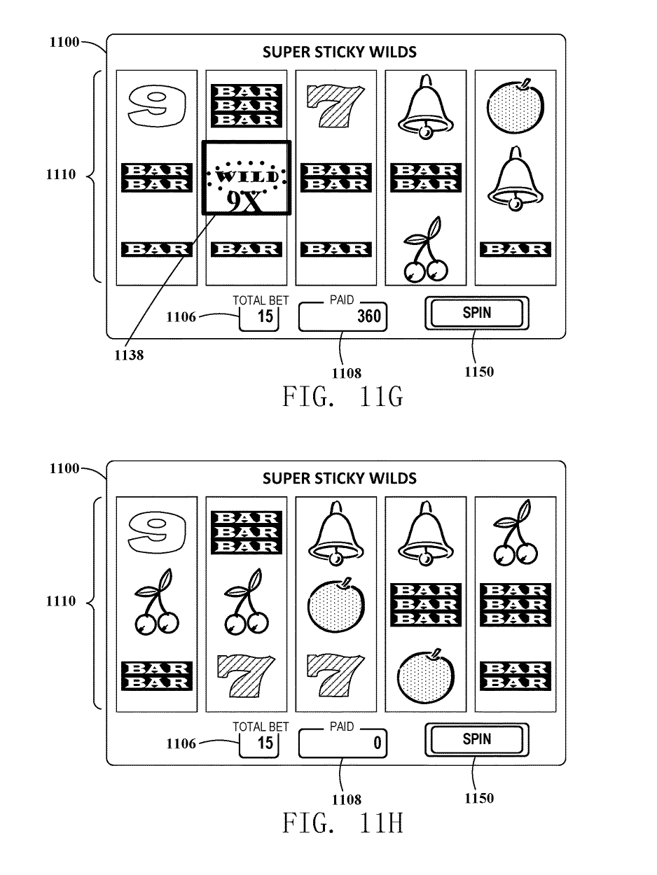

FIGS. 9A-9H, 10A-10H, and 11A-11H are example embodiments that illustrate some of the possible ways the inventive principles can be implemented. FIGS. 9A-9H illustrate embodiments that use a sticky multiplier wild symbol that decrements an initial multiplier value on the locked multiplier wild symbol over subsequent games until a multiplier value reaches 1×, at which time the wild becomes unlocked and spins away. FIGS. 10A-10H illustrate embodiments where three bonus symbols are respectively needed on reels 3, 4, and 5 to trigger a second screen bonus. Here, if a bonus symbol lands on any of these three reels, but not all the bonus symbols are received to trigger the bonus, the bonus symbol “sticks” or is locked on the game grid and a lock counter is associated with the locked bonus symbol. The bonus symbol becomes unlocked if the bonus is triggered, if a bonus buster symbol is received on the game grid, or if the bonus counter reaches zero. As shown in FIGS. 9A-9H, the bonus counter is not numeric, but is image based. In other embodiments, the counters can be numeric or implemented in other manners. FIGS. 11A-11H, illustrate a “changing” wild that can mature into a locked wild, and then a multiplier wild based on other triggering symbols received on the game grid.

FIGS. 9A-9H illustrate another game play progression embodiment of a slot gaming device display 900. Referring to FIGS. 9A-9H, a video slot display 900 includes a main game play area 910 (game grid), which displays portions of five game reels each having a plurality of game symbols 920, and a secondary area that includes various meters and buttons, such as a “Bet” meter 906, a “Paid” meter 908, and a “SPIN” button 950. As shown in FIG. 9A, a sticky wild 930 with an initial multiplier value of “4×” is received as a first game outcome. Although no symbol combinations are associated with award values in the first game outcome the wild multiplier 930 is locked on the game grid 910 when the reels are spun in the second game event, as shown in FIG. 9B. Note, the multiplier value of the locking wild symbol 930 is decremented by one for the second game event.

FIG. 9C illustrates the outcome of the second game event. Again, there are no winning symbol combinations. FIG. 9D illustrates the outcome of a third game event. Here, an incrementing sub-symbol overlay 935 is present on the game grid 910 as part of the game outcome. In addition, four lemon symbols are received using the multiplier wild 930 to double the normal award for this symbol combination. In FIG. 9E, note that the incrementing sub-symbol 935 has incremented the multiplier value of the locked wild symbol 930 and it was not decremented for this fourth game event. Additionally, note that a non-locking wild symbol was received in the fourth game reel. In other embodiments, the multiplier value of the locked wild symbol 930 may still be decremented. In FIG. 9F, a second locking wild symbol 932 is received with an initial multiplier value of “3×” in the fifth game event. Here, multiple winning symbol combinations are present, which is more likely to occur with each locked wild symbol present on the game grid 910. In FIG. 9G, a game outcome for a sixth game event is shown. Note that the multiplier value for the first locking wild symbol 930 has now been decremented to a “1×” value. Hence, this wild symbol 930 will become unlocked and spin away in a subsequent game event. In FIG. 9H, a game outcome for a seventh game event is shown. As mentioned above, the wild symbol 930 was unlocked and has spun away with the reel spin leaving its symbol position open for a randomly determined symbol.

FIGS. 10A-10H illustrate another game play progression embodiment of a slot gaming device display 1000. Referring to FIGS. 10A-10H, a video slot display 1000 includes a main game play area 1010 (game grid), which displays portions of five game reels each having a plurality of game symbols 1020, and a secondary area that includes various meters and buttons, such as a “Bet” meter 1006, a “Paid” meter 1008, and a “SPIN” button 1050. As shown in FIG. 10A, a sticky bonus symbol 1030 with an initial lock counter 1040 of three (shown by the three lightning bolts) is received as a first game outcome. Although the bonus was not triggered by the first game outcome, the bonus symbol 1030 is locked on the game grid 1010 when the reels are spun in the second game event, as shown in FIG. 10B. Note, the lock counter 1040 of the locking bonus symbol 1030 is decremented by one for the second game event.

FIG. 10C illustrates the outcome of the second game event. Again, the bonus event is not triggered by the second game outcome. FIG. 10D illustrates the outcome of a third game event. Here, a second locking bonus symbol 1032 with a second lock counter 1042 is received on the third game reel. As this second bonus symbol 1032 and the first bonus symbol 1030 on the fourth reel are locked for at least one more game, the player only needs to receive a bonus symbol on the fifth reel to trigger the second screen bonus. In FIG. 10E, not only did the player not get the last bonus symbol on the fifth reel, but the player also received a bonus buster symbol 1060, which unlocks all locked bonus symbols regardless of the lock count values.

In FIG. 10F, a third locking bonus symbol 1034 is received with a lock counter 1044 value of three on the fifth reel in the fifth game event. In FIG. 10G, a game outcome for a sixth game event is shown. Note that the third bonus symbol 1034 remained locked, and the player received bonus symbols 1036, 1038 on the third and fourth reels, respectively, thereby triggering a second screen bonus. As the bonus is triggered, all bonus symbols now become unlocked for the next game regardless of any remaining lock count values. In FIG. 10H, a game outcome for a seventh game event is shown. As mentioned above, the bonus symbols 1034, 1036, 1038 were unlocked and have spun away with the reel spin leaving their symbol position open for randomly determined symbols.

FIGS. 11A-11H illustrate another game play progression embodiment of a slot gaming device display 1100. Referring to FIGS. 11A-11H, a video slot display 1100 includes a main game play area 1110 (game grid), which displays portions of five game reels each having a plurality of game symbols 1120, and a secondary area that includes various meters and buttons, such as a “Bet” meter 1106, a “Paid” meter 1108, and a “SPIN” button 1150. As mentioned above, these illustrated embodiments, lock, transform, and mature wild symbols when activator symbols are present on the game grid. Referring to FIG. 11A, a wild symbol 1125 is received as part of a first game outcome. However, with no activator symbols present, the wild symbol acts like a conventional wild symbol and does not lock in place. In FIG. 11B, all game reels spin through the game grid 1110 as part of second game event.

FIG. 11C illustrates the outcome of the second game event. Here, another wild symbol is received, along with an activator symbol 1140. With the presence of the activator symbol 1140, the wild symbol becomes a locked wild symbol 1130. Here, the locking wild will increment a multiplier value for the next five games, with a chance to become really large in the presence of further activator symbols 1140, which double any multiplier values. FIG. 11D illustrates the outcome of a third game event. Here, the locking wild 1132 has incremented a multiplier value up to “2×” for this game. The four lemon symbols pay in this game outcome and are helped by the multiplier of the locked wild 1132, which doubles the normal award for this symbol combination. In FIG. 11E, the locked wild 1134 again gets its multiplier value incremented. Note that another wild symbol 1125 is present on reel 4, but the absence of an activator symbol means this wild symbol will not lock.

In FIG. 11F, another activator symbol 1140 is received. Here, instead of the locked wild symbol 1136 having its multiplier value incremented to only “4×”, the presence of the activator symbol 1140 doubles the multiplier value up to “8×.” Additionally, if other wild symbols were present on the game grid 1110, they would become locked in the presence of the activator symbol 1140. In FIG. 11G, a game outcome for a sixth game event is shown. Note that the multiplier value for the locking wild symbol 1138 has now been incremented to a “9×” value. As this is the fifth game using the locked wild symbol 1138, it will now become unlocked and spin away in a subsequent game event. In FIG. 11H, a game outcome for a seventh game event is shown. As mentioned above, the wild symbol 1138 was unlocked and has spun away with the reel spin leaving its symbol position open for a randomly determined symbol.

The foregoing description of the exemplary embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A gaming device comprising:
a game display having a game grid of symbol positions;
a wager input device structured to receive physical currency or currency based tickets, the currency or currency based tickets establishing a credit balance, the credit balance being increasable or decreasable based at least on wagering activity; and
a processor operable to:
receive a signal to initiate a first gaming event in response to placement of a wager, the wager decreasing the credit balance;
determine an outcome for the first gaming event by randomly determining symbols to be displayed in the game grid on the game display;
display the determined outcome of the first gaming event on the game display;
determine if an incrementing symbol appears on the game grid as part of the determined outcome for the first gaming event;
provide any awards for symbol combinations based on the determined outcome of the first gaming event, where provided awards increase the credit balance;
receive a signal to initiate a second gaming event in response to placement of a wager, the wager decreasing the credit balance;
when an incrementing symbol appears on the game grid in the first gaming event:
increment the incrementing symbol by incrementing a value associated with the incrementing symbol, and
lock the incrementing symbol in a symbol position on the game grid presently occupied by the incrementing symbol during the second gaming event;
determine an outcome for the second gaming event by maintaining the positions of the locked symbol on the game grid and randomly determining symbols to be displayed in non-locked symbol positions of the game grid; and
provide any awards for symbol combinations based on the determined outcome of the second gaming event, where provided awards increase the credit balance.

2. The gaming device of claim 1, wherein the value associated with the incrementing symbol is a multiplier value.

3. The gaming device of claim 1, wherein the value associated with the incrementing symbol is a game event count value.

4. The gaming device of claim 1, wherein the value associated with the incrementing symbol is incremented over subsequent game events until the value reaches a predefined threshold.

5. The gaming device of claim 1, wherein the incrementing symbol is a wild symbol.

6. The gaming device of claim 1, wherein the incrementing symbol is a bonus symbol.

7. The gaming device of claim 1, wherein the value associated with the incrementing symbol is shown graphically on the incrementing symbol.

8. The gaming device of claim 1, wherein the processor is further operable to determine if an activator symbol is present on the game grid as part of outcome for the first game event, where the activator symbol modifies the value associated with the incrementing symbol.

9. The gaming device of claim 1, wherein the value associated with the incrementing symbol is incremented over subsequent game events until a feature termination symbol is received as part of a subsequent game outcome.

10. A gaming device comprising:
a game display having a game grid of symbol positions;
a wager input device structured to receive physical currency or currency based tickets, the currency or currency based tickets establishing a credit balance, the credit balance being increasable or decreasable based at least on wagering activity; and
a processor configured to:
receive a signal to initiate a first gaming event in response to placement of a wager, the wager decreasing the credit balance;
determine an outcome for the first gaming event by randomly determining symbols to be displayed in the game grid on the game display;
display the determined outcome of the first gaming event on the game display;
determine if an incrementing multiplier symbol appears on the game grid as part of the determined outcome for the first gaming event, the incrementing multiplier symbol associated with a first multiplier value;
provide any awards for symbol combinations based on the determined outcome of the first gaming event, where any awards associated with symbol combinations that include the incrementing multiplier symbol are multiplied by the multiplier value of the incrementing multiplier symbol, and where provided awards increase the credit balance;
receive a signal to initiate a second gaming event in response to placement of a wager, the wager decreasing the credit balance;
when an incrementing multiplier symbol appears on the game grid in the first gaming event:
increment the first multiplier value to generate a second multiplier value associated with the incrementing multiplier symbol, and
lock the incrementing symbol in the symbol position on the game grid during the second gaming event;
determine an outcome for the second gaming event by maintaining the positions of the locked incrementing symbol on the game grid and randomly determining symbols to be displayed in non-locked symbol positions of the game grid; and
provide any awards for symbol combinations based on the determined outcome of the second gaming event, where provided awards increase the credit balance.

11. The gaming device of claim 10, wherein the incrementing multiplier symbol is a wild symbol that substitutes for at least one other symbol.

12. The gaming device of claim 10, wherein the processor is further configured to increment the incrementing multiplier symbol in subsequent gaming events until the multiplier value reaches a predefined maximum value.

13. The gaming device of claim 10, wherein the processor is further configured to increment the incrementing multiplier symbol in subsequent gaming events for a predefined number of subsequent gaming events.

14. The gaming device of claim 10, wherein the processor is further configured to increment the incrementing multiplier symbol in subsequent gaming events until the incrementing multiplier symbol is used in a symbol combination associated with an award.

15. A method of operating a gaming device including a game display having a game grid of symbol positions, a wager input device structured to receive physical currency or currency based tickets, the currency or currency based tickets establishing a credit balance, the credit balance being increasable or decreasable based at least on wagering activity, and a processor, the method comprising:
receiving a signal to initiate a first gaming event in response to placement of a wager, the wager decreasing the credit balance;
determining an outcome for the first gaming event by randomly determining symbols to be displayed in the game grid on the game display;
displaying the determined outcome of the first gaming event on the game display;
determining if an incrementing multiplier symbol appears on the game grid as part of the determined outcome for the first gaming event, the incrementing multiplier symbol associated with a first multiplier value;
providing any awards for symbol combinations based on the determined outcome of the first gaming event, where any awards associated with symbol combinations that include the incrementing multiplier symbol are multiplied by the multiplier value of the incrementing multiplier symbol, and where provided awards increase the credit balance;
receiving a signal to initiate a second gaming event in response to placement of a wager, the wager decreasing the credit balance;
when an incrementing multiplier symbol appears on the game grid in the first gaming event:
incrementing the first multiplier value to generate a second multiplier value associated with the incrementing multiplier symbol, and
locking the incrementing symbol in the symbol position on the game grid during the second gaming event;
determining an outcome for the second gaming event by maintaining the positions of the locked incrementing symbol on the game grid and randomly determining symbols to be displayed in non-locked symbol positions of the game grid; and
providing any awards for symbol combinations based on the determined outcome of the second gaming event, where provided awards increase the credit balance.

16. The method of claim 15, wherein the incrementing multiplier symbol is a wild symbol that substitutes for at least one other symbol.

17. The method of claim 15, further comprising incrementing the incrementing multiplier symbol in subsequent gaming events until the multiplier value reaches a predefined maximum value.

18. The method of claim 15, further comprising incrementing the incrementing multiplier symbol in subsequent gaming events for a predefined number of subsequent gaming events.

19. The method of claim 15, further comprising incrementing the incrementing multiplier symbol in subsequent gaming events until the incrementing multiplier symbol is used in a symbol combination associated with an award.

20. The method of claim 15, further comprising incrementing the incrementing multiplier symbol in subsequent gaming events until a feature terminating symbol is received in a subsequent gaming event.
